(19) United States
(12) Patent Application Publication
(10) Pub. No.: US 2005/0235560 A1
(43) Pub. Date: Oct. 27, 2005

(54) Integrated reactor for the thermal coupling of reactions and method for controlling the temperature field in such a reactor

(76) Inventor: Oliver Marquardt, Stuttgart (DE)

Correspondence Address: KENYON & KENYON, ONE BROADWAY, NEW YORK, NY, 10004, US

(21) Appl. No.: 11/058,377

(22) Filed: Feb. 14, 2005

(30) Foreign Application Priority Data
Feb. 14, 2004 (DE) 10 2004 007 344.9

(51) Int. Cl. B01J 8/00

(52) U.S. Cl. 48/127.9

(57) ABSTRACT

An integrated reactor is introduced for the thermic coupling of at least in each case one exothermic and one endothermic reaction having at least in each case two structures spatially separated from each other for guiding at least in each case two fluid streams, the structures having a catalytic coating. The catalytic coating is structured as a function of location.

### FIELD OF THE INVENTION

The present invention relates to an integrated reactor for the autothermic coupling of reactions. It also relates to a method for controlling the temperature field in such a reactor.

### BACKGROUND INFORMATION

The energetic integration of several continuously or periodically carried out high temperature reactions in a reactor is the current subject matter of worldwide research activities. Some applications require special reactor geometries as a function of the educts used, or a special catalytic structuring. As an application, let us mention here the integration of an exothermic oxidation reaction, preferably carried out catalytically, using an overall endothermic reaction, the steam reforming of low alkanes. A special reactor geometry may become necessary for achieving a temperature profile that permits high conversions in both reactions.

Processes for producing hydrogen have increasingly gained interest in recent years. The target applications of these methods are, among other things, stationary or mobile fuel station heating systems.

The coupling of endothermic reactions with exothermic reactions, in which the heat of the reaction products is used as completely as possible for the temperature rise of the inflows, is generally designated as “autothermic reaction control” Thus, for example, in an autothermic reforming method, the oxidation reaction and the reforming reaction are coupled in one reaction volume.

The thermic control, especially of heterogeneous catalyzed chemical processes, is an important factor for the optimization of the reaction control. In conventional fixed bed reactions, for example, these reactions often cause an unbalanced temperature profile, i.e. undesired temperature spikes may occur, or the reaction may locally be brought to a stop because of temperatures that are too low, or freeze, as it were. As is well known, the choice of a specific catalyst also influences the selectivity of reactions, the selectivity often being temperature-dependent. In other words, selectivity is interfered with by an unbalanced temperature profile. A catalyst may also be made unstable or may be damaged at too high or too low temperatures. Finally we should mention so-called runaway of reactions, i.e. a rapid development of the reaction speed in response to an uncontrolled increase in the temperature level.

It is known that the temperature control in the integration of the reaction systems of steam reforming and the catalytic combustion of hydrocarbons or hydrocarbon mixtures turn out to be non-trivial: Excess temperatures above approximately 950° C. should be avoided, in order to prevent clear damage to the known catalyst systems. On the other hand, the temperature on the oxidation side must not drop too much, so that the oxidation reaction is able to make available sufficient heat for the reforming. In addition, the steam reforming reaction, as an equilibrium reaction, requires that the exit temperature in the catalytic region of the reaction is as high as possible. In response to a temperature drop near the reactor outlet the danger is great that the conversion of the reforming reaction is diminished as a result of undesired reverse reactions.

From PCT International Published Patent Application No. PCT 01/94005, a catalytic plate reactor is known which has internal heat recuperation, which is used in a method for carrying out at least one exothermic and at least one endothermic reaction in one and the same reactor housing. In this context, the at least one exothermic and the at least one endothermic reactions take place in the same fluid stream at least partially separated locally, the fluid stream being guided along a plate-like wall that is on both sides at least partially catalytically coated, and being at least partially converted on that. In this context, the fluid is turned around at one end of the wall and is further converted at the backside of the wall.

European Published Patent Application No. 0 214 432 describes a device for generating synthesis gas under increased pressure from hydrocarbons in a catalytic, endothermic reforming member having a cylindrical pressure vessel and a plurality of reformer tubes heated from the outside and filled with catalyst, and in an adjacent partial-oxidation member that is greater in diameter than the aforementioned reforming member, in the form of a pressure vessel having a closed end into which the reformer tubes project with their free ends, and into which the reformed gas from the reformer tubes as well as additional hydrocarbons and oxygen or oxygen-containing gas are introduced. In the cylinder wall of the partial oxidation member, there is also mounted a plurality of supply devices for hydrocarbons and/or oxygen or oxygen-containing gas, whose center axes are aligned at an angle to the radial line and from parallel to inclined to the radial plane, and whose clearance from the outflow ends of the reformer tubes is dimensioned so that in the free partial oxidation member a rotating loop flow of the gases is created, and the product gas flows out in the outward direction, in order then to flow around the reformer tubes, to heat them, and to leave the reformer member through a short outlet pipe.

From German Published Patent Application No. 199 53 233, an autothermic reactor control is known for the direct coupling of endothermic and exothermic reactions, the two reaction streams being guided separately. The cold inflows of the two reaction fluids are heated in heat exchangers by hot effluents having in each case approximately the same heat capacity as the inflow, by suitable measures a prereaction of the reaction fluid of the exothermic reaction in the heat exchanger being avoided, and both fluids enter separate sections of a reaction chamber which are formed so that the respective reactions take place in them, and, in this context, an intensive heat transport takes place between the two fluids and parallel to the main flow direction, so that local overheating of the fluid for the exothermic reaction and local undercooling of the fluid for the endothermic reaction may largely be avoided, and the hot effluents from the reaction chamber are used for preheating the cold inflows.

Finally, German Patent No. 33 45 064 describes a method for generating a synthesis gas by reacting hydrocarbons under higher pressure by endothermic, catalytic steam reforming and catalytic autothermic reforming while using oxygen or oxygen-containing gas, in which the temperature of the product gas of the autothermic reforming is reduced by the admixture of a colder gas, before it heats the tubes of the steam reformer.

The disadvantage in the devices and methods of the related art named is that in the direct autothermic coupling used in this context, the synthesis gas is diluted by nitrogen, which is carried in by the oxygen or the air used for oxidation. This may lower the efficiency of subsequently situated process steps, such as fuel cells.

### SUMMARY OF THE INVENTION

The reactor according to the present invention has the advantage, compared to the related art, that a uniform temperature profile may be achieved in the reactor.

An additional advantage is that a lower load of the catalysts used may be achieved. Advantageous further refinements of the present invention result from the measures indicated in the dependent claims.

Thus, it is advantageous, for example, if the structures for guiding the fluid streams are made of metallic material.

It is also advantageous if the fluid streams may be divided to several structures.

### BRIEF DESCRIPTION OF THE DRAWINGS

FIG. 1 shows a top view of a reaction position according the present invention.

FIG. 2 shows a qualitative temperature profile along the run length of the reactor according to the present invention.

### DETAILED DESCRIPTION

The present invention relates especially to processes for generating synthesis gases from hydrocarbons. Short-chained hydrocarbons such as alkanes or mixtures of alkanes and higher hydrocarbons find preferred application. Of course, these substances may first be obtained in a previously occurring process from other educts, such as liquid hydrocarbon mixtures such as gasoline or Diesel. In this context, for the energetic integration, the following example shows the coupling of an endothermic steam reforming reaction, in a fluid-guiding channel structure, with a catalytic combustion (oxidation) in an additional fluid-guiding channel structure. The two channel structures have no fluid connections to each other, and are therefore spatially separate from each other. Thus one obtains an indirectly autothermic coupling, in which the combustion reaction makes available approximately the heat of reaction of the reforming reaction. This method differs from the so-called direct autothermic reforming method, which couples the oxidation reaction and the reforming reaction simultaneously in one reaction volume. In the present invention, there is no dilution of the synthesis gas by nitrogen carried in in direct autothermic reforming by the air used for oxidation. The method, on which the present invention is based, makes the advantages achieved usable by a compact heating method in a compact reactor.

One should note that the reactor according to the present invention is not limited to application in such systems, but may be used in all processes in which reaction systems having high reaction enthalpy are coupled.

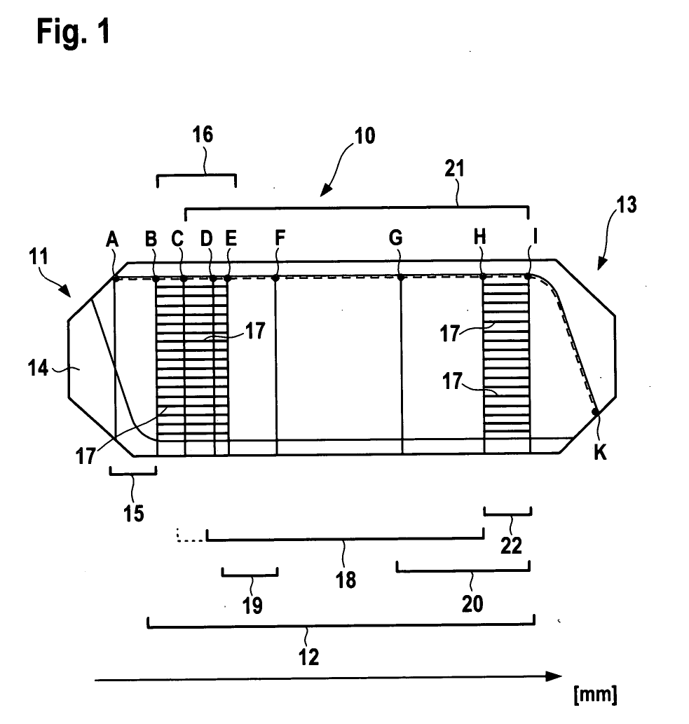

FIG. 1 shows an integrated reactor 10 according to the present invention which subdivides into a fluid intake region 11, a reaction region 12 and a fluid flow off region 13. For the example named, the following describes only actual reaction region 12 of the reactor, i.e. the region in which the substance transition and/or the heat transfer essential for the reactor behavior takes place. The remaining regions of the reactor, i.e. fluid intake region and fluid flow off region 11, 13, may be designed in any desired manner. Thus, it is also possible, for example, to supply a first fluid to a first corner of the reactor, and to supply a second fluid to a corner lying opposite the first corner. Reaction region 12 is shown in FIG. 1 as a top view of a reaction position 14 of the coupled reaction apparatus. By reaction position one should understand a preferably metallic structure that is used in reaction region 12 for fluid guidance and for influencing the heat balance.

Per reaction system, in the present example steam reforming and oxidation, at least one fluid stream is supplied to the reaction region. This fluid stream may have, of course, been created directly upon entrance into the reactor by mixing two or more partial flows. The fluid stream supplied in each case is distributed to a plurality of reaction positions of the respective reaction system. The reaction positions of both reaction systems (steam reforming and oxidation) are preferably stacked alternatingly. By doing that, a great symmetry may be achieved in the reactor system with respect to heat transfer. In this context, from a manufacturing technology point of view, it is possible to stack up to 200 layers one above the other, but in the present case, a range of 10-50 layers appears to make sense. The thickness of the individual layers, in this instance, is preferably between 500-3000 μm, preferably close to 1000 μm. The fluid inflow and outflow 11, 13, takes place preferably in the vicinity of the edges that form because of the stacking of the reaction layers. This makes a fluid-tight construction of the reactor possible, no planar sealing being necessary. The reactor according to the present invention may, under certain circumstances, also be operated using more than two reaction systems.

Measures for evening out the flow, i.e. for the uniform flow supply of the reaction layers such as an appropriate layout of the fluid cross sections, the use of sintered metal elements for evening out the flow during fluid intake and outflow, correspond to the related art, and may be integrated into the reactor according to the present invention.

The educts are preheated, before entering into the reactor, to a temperature in the range of 200-900° C., in the example of the coupled process introduced here preferably to ca. 650-750° C. In addition, preferably a cocurrent flow in the reaction region is assumed. However, alternatively a counterflow of the fluids instead of the cocurrent flow is also conceivable. As a special example of the indirect autothermic reaction control, in which no dilution of the synthesis gas takes place, let us look at the thermic integration of “methane-steam reforming” and the catalytic combustion of a methane-containing mixture in the reactor:

Methane-Steam Reforming:

CH₄+H₂O⇄CO+3H₂
CH₄+2H₂O⇄CO₂+4H₂
   Catalytic Combustion:
CH₄+2O₂→CO₂+2H₂O

Simulation models, whose parameterization is based on experimental tests, show that, because of the targeted formation of the heat transfer and the mass transfer, great advantages with respect to the loading of the catalysts applied on the structures and the combustion catalysts may be achieved. At reactor throughputs that make sense economically, the catalytic combustion of methane runs with good conversions only at relatively high temperatures above ca. 650° C. By a structured, location-dependent coating of the structures for fluid control, which have the educts of the reforming reaction flowing over them, one may achieve that the reforming reaction does not excessively chill the reactor. For this, a first partial conversion of the educts of the reforming reaction is achieved in a first catalytic region 19 (FIG. 1, region E-F). In the part of the reactor subsequent to this, in a second catalytically coated region 20 (FIG. 1, region G-I) an additional part of the reforming-side educt flow is converted.

Consequently, the selected reactor structuring may be drawn upon for controlling the temperature field in the reactor.

Besides the described structuring of the catalytic layer on the reaction layers of the reforming reaction, the processes of the endothermic methane-steam reforming and the exothermic total oxidation are locally decoupled by a location-dependent structuring of the heat transfer in the reaction region. For this, the heat transfer between adjacent reaction layers is purposefully reduced in partial regions of the reactor (reactor region without crossbars, cf. FIG. 1, region E-H) since in that location there is no solid conduction between the adjacent structures. The heat transfer in for steam reforming then takes place in great measure by the axial heat conduction of the reactor material along, or even counter to, the fluid flow. Thereby an adequately high oxidation-side temperature may be achieved—an excessive temperature drop in partial regions of the reaction layer, in which the oxidation reaction is being carried out, is prevented by the heat withdrawal on the reforming side.

The heat transfer between the adjoining reaction layers may be organized in supplement to location-dependent structuring of the catalytic regions (e.g. catalyst present or not) in a location-dependent manner, in order thereby to influence the temperature profile in the reactor in a positive mannwer. The structuring to influence the heat transfer between neighboring reaction layers along the fluid running length, in this context, is as follows.

As may be seen in FIG. 1, first of all a heating-up region 15 follows fluid intake region 11, and after that, there follows a region 16 having structures for influencing the heat transfer between the stacked reaction layers. These structures may, for instance, be composed of crosspieces 17, but other structures known by one skilled in the art are also conceivable. The crosspieces are made preferably of the same material as the reaction layers (metal), and may be manufactured in one piece with these, of a basic material. When it comes to the basic material, preferably steels are involved which have sufficient resistance to corrosion and rigidity at high temperatures. The crosspieces are used both for fluid distribution and for heat transfer from the oxidation layer to the reforming reaction layer. A region 18 connects to region 16 that is provided with crosspieces 17, which in its constructive shaping in cross section is equivalent to a level gap. Alternatively, the location-dependent structuring of the heat transfer may be omitted depending on the catalysts used. The location-dependent specification of crosspieces for influencing the heat transfer behavior is valid, as a rule, in the same way for both reaction layers.

FIG. 1 shows a reaction layer 14 for the oxidation reaction. Below that is arranged the corresponding reaction layer for the reforming reaction (not shown). Consequently, the reactor is made up of an alternating stacking of the reaction layers for the two different reactions as well as educt inflows. For simplification, in the light of reaction layer 14 it is indicated in which regions a catalytic coating has been applied. Thus, one may see in FIG. 1 that, for the catalysts selected in this example, a coating for the oxidation reaction layer is only applied in region 18, while the remainder of this reaction layer has no catalytic function. It is also possible to let the coating begin already at point C (shown by a broken line in FIG. 1). In the present example, for the reforming reaction layer a catalytic coating is provided in regions 19 and 20. As a function of the present catalyst system, variables such as beginning/end of the coatings, beginning/end of the reaction regions, etc, are specified.

The points A-K shown in FIG. 1 along the length of the reactor indicate the location-dependent change in the reactor structuring. In this context, points A and K designate the location of supplying and removing the respective fluid flows, point B indicates the beginning of region 16 that is provided with crosspieces 17, and point E indicates its end. At point C oxidation region 21 begins, whose end is marked by point I. Point H indicates the beginning of a second region 22 provided with crosspieces 17, which ends at point I. Points F and G mark the end of the first reforming region and the beginning of the second reforming region.

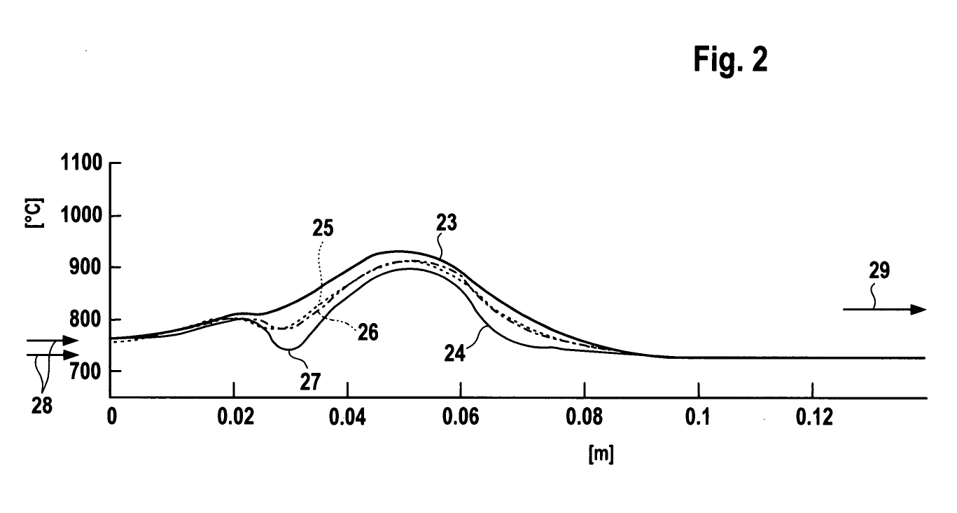

The simulation results mentioned show that the reactor geometry according to the present invention satisfies the requirements with respect to high conversions in a broad load range. For the demonstration of the temperature behavior, FIG. 2 shows the temperature curve for an operating point, that is, a location-dependent temperature curve in response to a specified oxidation-side/reforming-side inflow of the application described. In this context, solid lines 23, 24 indicate the respective structures (solids) in which reforming 23 and catalytic oxidation 24 are undertaken, whereas dotted and dash-dotted lines 25, 26 show the temperature curve of the fluids used. At absolute running length 0, the fluids of both reactions enter the reactor (arrows 28, Point A in FIG. 1). First one may observe a temperature increase in the region of crosspieces 17 (region B-E), since the oxidation catalyst region already begins here (point C in FIG. 1). In the region without crosspieces (region E-H in FIG. 1) a temperature drop is to be observed, since the reforming catalyst region (region 19 in FIG. 1) begins here, and because of the region formed as a level gap (18 in FIG. 1) a comparatively poor heat transfer exists, so that the temperature of the oxidation structure remains sufficiently high. The short reforming catalyst region (19 in FIG. 1) is used to limit heat sink 27. In a middle region (between regions 19 and 20 in FIG. 1), for the extensive heat liberation of the oxidation reaction, the heat is transported in particular via solid conduction into first and second reforming zones 19, 20. In this middle region there is no reforming catalyst, for obtaining a sufficient heating-up for the following conversion. At the end of reaction region (12 in FIG. 1) there are crosspieces 17 present again (region H-I in FIG. 1) for fluid control and for compensation of the temperatures (oxidation and reforming), so that the heat liberated on the oxidation side is coupled into the reforming as well as possible. The fluid outflow takes place in the direction of arrow 29 (region 13 in FIG. 1). The heat withdrawal by the reforming reaction is easily recognizable in the light of the gradients in the solid temperature. The advantage of relatively small temperature gradients in the reactor is recognizable.

The influencing of the heat transfer between the reaction layers is also easily recognizable from FIG. 2. In reactor regions in which there are crosspieces, the wall temperatures of the adjoining reaction layers to a great extent adjust to each other.

Preferably, the catalytic layer is applied only to one channel side, since in this way there results a simplification of the coating method, and a control of the coating before assembling the reactor is possible. The other channel side or the remaining exposed metallic surfaces in the reactor may, however, also be coated for reasons of corrosion protection, and may possibly be made to function catalytically.

As has been mentioned, the structures for guiding the fluid flows have at least partially a catalytic coating. In this context, in the case of catalyst systems for methane-steam reforming, preferably Rh or Ni or mixtures of the two elements are involved as active components. As ceramic carriers onto which the catalytic coating is applied or into which it is introduced, for instance, ZrO₂, Al₂O₃ or modifications thereof are suitable. Pt or Pd on ceramic carriers are preferably used for the catalyst system for methane-total oxidation. It should be noted that the activity of the catalysts used may influence the exact design and the lengths of the catalytically coated regions. Furthermore, it is possible to apply different catalyst within the same reaction layer at different positions. Thereby, several different catalytic functions may be integrated in one reactor and/or catalysts used, which, dependent on location, assume various functions, such as a targeted reduced catalyst activity, for instance, by a diffusion barrier.

Furthermore, the reactor structuring in the two outer reaction layers, which delimit the reactor and on which preferably an exothermic reaction is carried out, may be selected differently, so as to influence the temperature profile in the reactor in a targeted manner. In this context, the structuring is selected in such a way that it counteracts the negative effects of the unavoidable heat losses to the insulating material, i.e. the structuring is selected as a function of fuel gas, for instance, H₂ is supplied distributed locally in order to distribute the heat liberation. As the educt flow, in this case, one may also use the educt flow of the heat-supplying reaction, which supplies the additional reaction structures of the reactor, in the present example, a methane-oxygen-containing mixture. Alternatively, the exothermic reaction may also be carried out in the edge region using an additional substance flow, for instance, the afterburning of a, for instance, hydrogen-containing exhaust gas flow from fuel cells, for example.

The overall running length in the reactor is changeable, i.e. a greater overall length offers more catalyst surface, and consequently a more complete conversion. Even the length of reactor regions 16, 22, in which crosspieces are present, may be adapted to the respective application, such as when other educts are used.

There may also be present additional structures for influencing the heat transfer between the stacked reaction layers (crosspieces) in the middle of the reactor for optimizing the temperature curve in the reactor, whereby an increased heat exchange results between the adjoining reaction structures, and consequently a lower temperature difference at the same running length. Furthermore, instead of crosspieces, it is possible to introduce other measures for influencing the heat transfer between the adjacent reaction layers. Thus, for example, the channel cross sections in partial regions of the reactor may be reduced, in order to increase the convective heat exchange of the fluid streams with the respective adjacent reaction layer. Channel cross sections that are a function of location may also be used for evening out the flow. In order to optimize the temperature field in the reactor, an additional stream may be metered in to a mass flux along the entire running length or in a location-dependent manner, which results in a distributed heat liberation and a lower temperature gradient. The metering in may be performed discretely, e.g. using a hole structure or in a planar manner, e.g. using a pore structure in the structures for stirring the fluid streams. The catalyst coating on the oxidation side may be interrupted in one region in which there is no catalyst on the reforming side. As a function of the activity of the catalyst used, positive effects may be achieved thereby with regard to the minimization of temperature maxima on the oxidation side. In that way the temperature maximum on the oxidation side may be diminished (cf. FIG. 2).

The location-dependent structuring a) of the catalytic zone and/or b) the creation of the heat exchange between the reaction layers may be used for carrying out other reactions or the use of other educt flows, as, for instance, for the use of long-chain hydrocarbons in partial conversion (not shown) in a prereaction zone (not shown) to methane and additional components.

Furthermore, the stacked metal structures may have various thicknesses, which has the advantage of material savings. Thus, for example, the structure on the oxidation side may be characterized by a lesser channel height for improved control of the exothermic behavior. In this connection, a decreased height of the reaction layers may also be used—preferably, the thickness of the individual layers is between 500-1000 μm. Besides that, the temperature profile is influenced thereby, i.e. changed axial heat conducting processes are created.

In reactor regions in which no catalytic functionalization takes place, a protective layer may be applied by known methods, such as CVD, vapor depositing, etc, for avoiding corrosion phenomena of the material structure. This protective layer is made, for example, of SiO₂ or other ceramic materials, Al₂O₃, ZrO₂, SiC, aluminum phosphates or the like. In another variant of the reactor according to the present invention, for the additional increased degree of compactness, a catalytic coating may also be applied to subregions of the underside of the adjoining reaction layer.

The integrated reactor according to the present invention, described above, offers advantages with respect to the temperature field in the reactor: The proposed geometry as well as the structuring of the catalyst should offer as optimal a fulfillment as possible of the requirements with respect to compactness, operability and long-term stability of such a system. In detail, the advantages are:
small loading of the catalysts preferably applied to the metallic walls, by comparatively low temperature gradients in all spatial dimensions, and thereby increased long-term stability of the connection metal—catalyst
small loading of the combustion catalyst by approximately isothermal relationships in the reactor, since the surface temperatures correspond approximately to the fluid temperatures, which leads to the following advantages:
   ageing procedures (e.g. sintering) are severely limited
   in the catalytic combustion great load spreading is possible, and at the same time, a low NOₓ emission takes place; because of the adjusted channel geometry, no uncontrolled homogeneous bringing of the reaction to completion is created
   very good heat transfer because of small channel dimensions adjusted to the reaction systems
   very good tracking of load changes
   relatively great insensitivity to changes in the catalyst activity
   operability over a broad inlet temperature range, preferably between 700-800° C.
   lower costs (catalysts)

1. An integrated reactor for the thermic coupling of at least in each case one exothermic and one endothermic reaction having at least in each case two structures spatially separated from each other for guiding at least in each case two fluid streams, the structures having a catalytic coating, wherein the catalytic coating is structured as a function of location.

2-32. (canceled)
